(19) United States
(12) Patent Application Publication
(10) Pub. No.: US 2003/0064740 A1
(43) Pub. Date: Apr. 3, 2003

(54) Method for status inquiry of at least one connector for user group and/or communication transmission device

(76) Inventor: Bernd Schneider, Muenchen (DE)

Correspondence Address: MORRISON & FOERSTER LLP, 1650 TYSONS BLVD. - SUITE 300, MCLEAN, VA, 22102, US

(21) Appl. No.: 10/220,223

(22) PCT Filed: Feb. 19, 2001
(86) PCT No.: PCT/DE01/00646

(30) Foreign Application Priority Data
Mar. 3, 2000 (DE) 100 10 462.2

(51) Int. Cl. H04Q 7/20

(52) U.S. Cl. 455/519; 455/560

(57) ABSTRACT

The invention relates to a status inquiry in a communication network from a particular communication transmission device, arranged as a switchboard and connected to a first exchange, for the purpose of establishing a connection to at least one connection and/or communication device of a user group, by means of at least one exchange. Said inquiry is directed from the first exchange to at least the second exchange, by means of a signaling path.

### CLAIM FOR PRIORITY

This application claims priority to International Application No. PCT/DE01/00646 which was published in the German language on Sep. 7, 2001.

### TECHNICAL FIELD OF THE INVENTION

The invention relates to a method for checking the status of at least one connection and/or communications terminal assigned to a subscriber group, and in particular, by means of a special communications terminal arranged in a communications network and structured as a switchboard.

### BACKGROUND OF THE INVENTION

Subscriber groups are typically related to the “Centrex” (Central Office and Exchange) characteristic, for example. The “Centrex” characteristic makes it possible for each communications terminal that is connected with a common switching center or to different switching centers, by way of connection lines, to be brought together as a Centrex group. The subscribers who belong to the Centrex group can then have almost the same service features made available to them as would be offered by a private branch exchange (PBX), if their subscriber terminals were connected to the latter, by the switching center that is responsible for them. Such Centrex groups can also be subdivided into Centrex sub-groups, for example business groups, to which a selection of service features is made available from the pool of the possible service features for Centrex subscribers. Examples of the service features that are related with the Centrex groups are described in a customer brochure titled “GeoCentrex: The Best Catch For Your Network” from Siemens AG, published in 1995 by the division of telecommunications networks, Hofmannstr. 51, D-81359 Munich, Order No. A-30808-X3093-X100-1-7635.

As in the case of private branch exchanges, a switching center responsible for the Centrex group can be equipped with a switchboard or a switchboard group. A switchboard for a Centrex group or for a Centrex sub-group is the central incoming contact point for outside callers and, where applicable, also for callers within Centrex sub-groups. A switchboard operator accepts calls, speaks with the caller, and can then forward the call to a desired subscriber or to the best-suited subscriber of the Centrex (sub)-group.

When forwarding the incoming call, the switchboard operator can perform actions such as breaking in on an existing call, breaking through a call block that the subscriber has set up, or diverting a call; i.e., selecting an alternative subscriber group subscriber. For reasons of time, forwarding generally takes place without a prior connection between the switchboard operator and the subscriber of the subscriber group who is to be reached. The connection or communications terminal of the subscriber may also be busy, the subscriber may not be present at the time and might have set up call forwarding on an answering machine at his/her communications terminal. An outside caller that does not belong to the subscriber group is generally quickly switched back again to the same switchboard, or to a different switchboard of a switchboard group, or he/she must terminate the call, call again, and present his/her wishes to a switchboard operator once again. In conventional private branch exchanges, switchboards are equipped with display fields on which a “not busy” or “busy” status of the communications terminals directly connected with the private branch exchange is displayed. This is done by means of physical monitoring of the connection line leading to the communications terminal in the private branch exchange. In this manner, a switchboard operator can check the status of the connection or communications terminal being called before forwarding the call and can carry out suitable actions on the basis of the status, such as breaking in on an existing call, breaking through a call block set up at the communications terminal of the subscriber being called, diverting the call, selecting an alternative communications terminal of the subscriber group or checking with the caller.

Problems in monitoring the status of the connections or communications terminals of a subscriber group occur, in particular, if a subscriber group is set up network-wide for subscribers whose communications terminals are connected to different switchboards. In addition, the switchboard is generally connected with a different switching center than the communications terminals. Accordingly, the method of procedure known for private branch exchanges cannot be applied to subscriber groups whose connections or communications terminals are distributed over several switching centers in the communications network.

### SUMMARY OF THE INVENTION

The task of the invention discloses a method for checking the status of at least one connection and/or communications terminal that is assigned to a subscriber group.

In one embodiment according to the invention, a status inquiry concerning at least one connection and/or communications terminal is directed from a first switching center to at least one second switching center via a signaling path in the communications network, by a switchboard connected with the first switching center, assigned to the subscriber group, for establishing a connection via the at least one second switching center, to at least one connection and/or communications terminal. By utilizing the signaling path available in the communications network according to the invention, no additional hardware equipment is required in the communications network. The advantages of the method according to the invention are particularly evident for a subscriber group set up network-wide.

It is preferable if the status inquiry received at the at least second switching center initiates checking of the status of at least one connection and/or communications terminal. Subsequently, a result message is sent to the first switching center. Depending on the result message, a connection is established to a called communications terminal of the subscriber group. In this manner, attempts to establish a connection that will not lead to a positive result can be avoided from the outset.

In accordance with an embodiment of the invention, a status at the communications terminal is represented by call forwarding that has been set up, or a status at the connection is represented by the fact that the connection line is busy.

It can also be provided that a signal is issued in the signaling path via a signal output channel No. 7.

Preferably, the so-called TCAP protocol (Transaction Capabilities Application Protocol) is used as the transmission protocol. The TCAP protocol also supports a signaling transmission mechanism in which no working connections are established, but rather signaling paths are required.

It is preferable if the checked status is displayed on the switchboard optically and/or acoustically. If the status of the at least one called communications terminal is displayed to a switchboard operator on the screen, the operator can give corresponding information to the caller and thereby better respond to the caller's needs.

If the communications network is a public telecommunications network, at least one second switching center is structured in accordance with a public digital long-distance switching center.

As mentioned initially, the subscriber group is preferably represented by a Centrex group or by a Centrex sub-group.

### BRIEF DESCRIPTION OF THE DRAWINGS

In the following, an exemplary embodiment of the invention is explained in greater detail, making reference to a drawing. The drawing shows:

FIG. 1 shows an exemplary constellation in the communications network according to the invention.

### DETAILED DESCRIPTION OF THE PREFERRED EMBODIMENTS

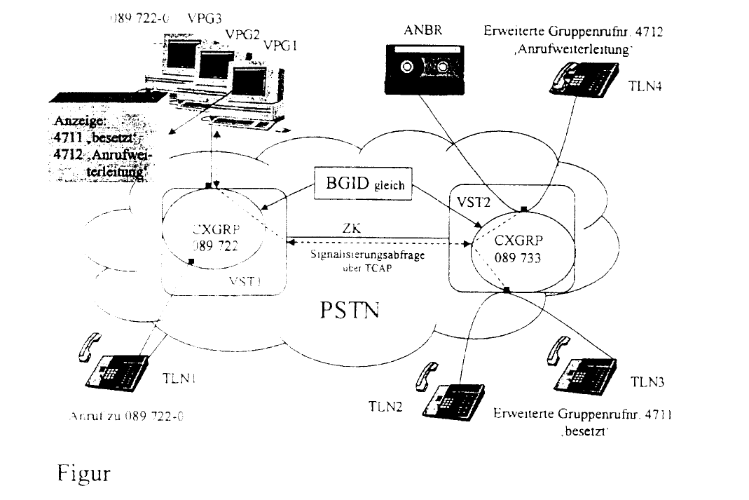

In FIG. 1, a “cloud” indicates a communications network PSTN; e.g., a public telecommunications network. There are two switching centers, VST1 and VST2 for example, present in the communications network. The switching center VST1 is connected with a switchboard group, for example with the group telephone number 089 722-0, which has several switchboards, for example VPG1 to VPG3. The content of the screen at switchboard VPG1, for example, is symbolized in the figure by a small box arranged next to the switchboards. Furthermore, a communications terminal TLN1 is connected with the switching center VST1. Within the switching center VST1, a local Centrex business group with the group telephone number 089 722 of a network-wide Centrex business group is indicated. Communications terminals TLN2 to TLN4 are connected with the switching center VST2. The communications terminal TLN4 has an expanded group telephone number; e.g., 4712. Also, call forwarding to an answering machine box ANRB connected to the switching center VST2 is set there. The communications terminal TLN3 with the group telephone number 4711, for example, has the status “busy,” brought about by a call on the connection line leading from the switching center VST2 to the communications terminal TLN3.

There is at least one signaling path ZK between the switching centers VST1 and VST2, for example the signal output channel No. 7. In addition, a local Centrex business group with the group telephone number 089 733 of the same network-wide Centrex business group CXGPR is indicated within the switching center VST2 as well as within the switching center VST1, to which the communications terminals TLN2 to TLN4, as well as the answering machine box ANRB, for example, are assigned.

The following scenario is possible with this constellation, in which the method according to the invention is implemented. A subscriber, for example, dials the telephone number 089 722-0 at his/her communications terminal TLN1. The call arrives at the switching center VST1, where it is forwarded to a switchboard, VPG1, for example. An operator at the switchboard VPG1 accepts this call. The calling subscriber informs the operator that he/she desires to be connected with the subscriber with the telecommunications terminal TLN3, which belongs to the business group with the group telephone number 089 733. Thereupon the operator directs a status inquiry concerning the telecommunications terminal TLN3 to the switching center VST1 via his/her switchboard. This switching center forwards the status inquiry to the switching center VST2, in the form of a signaling message, via a signaling path, for example ZK. Preferably, the TCAP protocol (Transaction Capabilities Application Protocol) is used as the transmission protocol via this signaling path, for which protocol is not necessary to establish a working connection via the communications network PSTN to the switching center VST2.

In addition to the status inquiry, a network-wide unambiguous business group identification number, BGID, for example, is transmitted to the switching center VST2 via the signaling path. Within the switching center VST2, a checking process then takes place as to whether the business group identification number of the business group present within the switching center VST1, with the group telephone number 089 722, agrees with the business group identification number of the business group present within the switching center VST2, with the group telephone number 098 733. If there is agreement, the switching center VST2 determines the status of the communications terminal belonging to the business group, for example TLN3. In the example, the communications terminal TLN3 has the status “busy.” Then the switching center VST2 passes a corresponding result report back to the switching center VST1 via the signaling path ZK. The switching center VST1 passes this result report to the switchboard VPG1, which displays the status of the communications terminal TLN3 optically on the screen, in a suitable manner.

Accordingly, the operator can inform the calling subscriber about the status of the desired telecommunications terminal and can initiate suitable actions, such as breaking into an existing call connection, at the request of the calling subscriber. If the calling subscriber wishes to speak with any other subscriber of the business group, additional status checks of other communications terminals belonging to the business group, for example also TLN4, can be carried out in an analogous manner, as described above, and displayed on the screen of a switchboard. Instead of using a screen display, the operator can be informed of the status of the communications terminals in question acoustically, for example by way of signal tones.

1. Method for checking the status of at least one connection and/or communications terminal (TLN2, . . . , TLN4) assigned to a subscriber group (CXGRP) by means of a special communications terminal (VPG1) arranged in a communications network (PSTN) and structured as a switchboard, which is assigned to the subscriber group, characterized in that a status inquiry concerning at least one connection and/or communications terminal is directed from the first switching center to at least one second switching center, via a signaling path (ZK) in the communications network, by a switchboard connected with a first switching center (VST1), for establishing a connection via the at least one second switching center (VST2), to at least one connection and/or communications terminal.

2. Method according to claim 1, characterized in that the status inquiry received at the at least second switching center (VST2) initiates checking of the status of at least one connection and/or communications terminal (TLN2, . . . , TLN4) and that subsequently a result message is sent to the first switching center.

3. Method according to claim 1 or 2, characterized in that a status at the communications terminal is represented by call forwarding that has been set up, or a status at the connection is represented by the fact that the connection line is busy.

4. Method according to one of the preceding claims, characterized in that a signal output channel No. 7 is provided in the signaling path.

5. Method according to one of the preceding claims, characterized in that the TCAP protocol (Transaction Capabilities Application Protocol) is used as the transmission protocol on the signaling path.

6. Method according to one of the preceding claims, characterized in that the checked status is displayed on the switchboard (VPG1) optically and/or acoustically.

7. Method according to one of the preceding claims, characterized in that the first and at least one second switching center (VST1, VST2) are switching centers arranged in a public telecommunications network.

8. Method according to claim 7, characterized in that the subscriber group is represented by a Centrex group or by a Centrex sub-group.
